(19) United States
(12) Patent Application Publication
(10) Pub. No.: US 2007/0058195 A1
(43) Pub. Date: Mar. 15, 2007

(54) Image input device and printing system

(76) Inventors: Mitsuo Nakamura, Kanagawa (JP); Takanori Fujii, Kanagawa (JP); Tatsuo Takaoka, Kanagawa (JP); Tomohide Machida, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/508,822

(22) Filed: Aug. 24, 2006

(30) Foreign Application Priority Data
Sep. 15, 2005 (JP) 2005-267739

(51) Int. Cl. G06F 3/12

(52) U.S. Cl. 358/1.15; 358/1.13

(57) ABSTRACT

An easy-to-use printing system is disclosed. The printing system includes an image input device having a serial interface unit, and an image output device having a serial interface unit. The image input device includes a network communication unit connected to a network for communicating various data, and when the image input device receives a printing job from a host device through the network communication unit, the image input device sends information of the printing job to the image output device through the serial interface unit so that the image output device outputs a print of the printing job.

### BACKGROUND OF THE INVENTION

1. Field of the Invention

The present invention relates to an image input device connected to one or more image output devices through a serial interface unit, an image input device having a serial interface unit, a printing system including an image output device having a serial interface unit, and a printing system including an image input device having a serial interface unit that is connected to plural image output devices each having a serial interface unit.

2. Description of the Related Art

In the related art, when outputting an image read by a scanner to a printer, the image is stored temporarily in a host device, such as a personal computer, and printing software installed in the host device is executed to print the stored image with a printer.

In such a printing system, since the presence of the host device is required, it is not easy to use; in addition, a user has to perform many operations.

To solve this problem, for example, Japanese Laid Open Patent Application No. 2001-257827 discloses a system in which a scanner and a printer are connected to a LAN (Local Area Network), the image read by the scanner is sent to the printer through the LAN with a server in between, and the printer prints out the image.

However, in the system of the related art, since the presence of the Local Area Network is required, the scale of the system is large, and it is not suitable for use in relatively small offices.

### SUMMARY OF THE INVENTION

The present invention may solve one or more problems of the related art.

A preferred embodiment of the present invention may provide an easy-to-use image output device and a printing system.

According to a first aspect of the present invention, there is provided an image input device connected to an image output device through a serial interface unit, comprising:

a network communication unit connected to a network for communicating various data,

wherein when the image input device receives a printing job from a host device through the network communication unit, the image input device sends information of the printing job to the image output device through the serial interface unit so that the image output device outputs a print of the printing job.

As an embodiment, the image input device further includes an image format conversion unit configured to convert an image format;

wherein

when the image input device receives a printing job from a host device through the network communication unit, the image format conversion unit converts information of the printing job, and the image input device sends the converted information to the image output device through the serial interface unit so that the image output device outputs a print of the printing job.

According to a second aspect of the present invention, there is provided an image input device connected to a plurality of image output devices through a serial interface unit, comprising:

a selection unit that, when a copy job of making a plurality of copies is submitted, selects one or more image output devices for use from the plural connected image output devices in response to the specified number of copies, and

the image input device sends image data obtained by reading to the selected image output devices to output respective prints.

As an embodiment, the selection unit selects the image output devices for printing. Alternatively, the selection unit selects the image output devices for printing in accordance with types of the image data to be printed.

According to a third aspect of the present invention, there is provided an image input device that is connected to a plurality of image output devices through a serial interface unit, comprising:

a network communication unit connected to a network for communicating various data,

wherein

when the image input device receives a printing job for printing a plurality of copies from a host device through the network communication unit, the image input device selects one or more image output devices for use from the plural connected image output devices in response to the specified number of copies, and sends information of the printing job to the selected one or more image output devices through the serial interface unit to output prints.

According to the present invention, since an image input device, such as a scanner, is connected to an image output device, such as a printer, through a serial interface unit, it is possible to provide a printing function with a simple system.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a block diagram schematically illustrating an example of a printing system according to an embodiment of the present invention;

FIG. 2 is a block diagram illustrating a configuration of the scanner SC according to the present embodiment;

FIG. 3 is a block diagram illustrating a configuration of the printer PT (PT1 through PTn) according to the present embodiment;

FIG. 4 is a sequence diagram exemplifying a copy operation according to the present embodiment, in which the scanner SC reads a copy of an image document, and the printer PT records and outputs the copy;

FIG. 5 is a flowchart exemplifying operations of the scanner SC during the copy operation as shown in FIG. 4;

FIG. 6 is a diagram showing an example of an error massage;

FIG. 7 is a sequence diagram illustrating an operation in which the personal computer PC sends a printing request to the printer PT through the scanner SC according to the present embodiment;

FIG. 8 is a flowchart illustrating operations of the scanner SC during the operation as shown in FIG. 7;

FIG. 9 is a sequence diagram exemplifying an operation in which the personal computer PC sends a log acquisition request to the printer PT through the scanner SC according to the present embodiment;

FIG. 10 is a flowchart exemplifying operations of the scanner SC during the operation as shown in FIG. 9;

FIG. 11 is a flowchart illustrating another example of operations of the scanner SC when the personal computer PC sends a printing request to the printer PT through the scanner SC according to the present embodiment;

FIG. 12 is a flowchart illustrating another example of operations of the scanner SC during the copy operation as shown in FIG. 4;

FIG. 13 is a flowchart illustrating still another example of operations of the scanner SC during the copy operation as shown in FIG. 4;

FIG. 14 is a block diagram schematically illustrating an example of a printer selection window according to the present embodiment; and

FIG. 15 is a flowchart illustrating yet another example of operations of the scanner SC during the copy operation as shown in FIG. 4.

### DESCRIPTION OF THE PREFERRED EMBODIMENTS

Below, preferred embodiments of the present invention are explained with reference to the accompanying drawings.

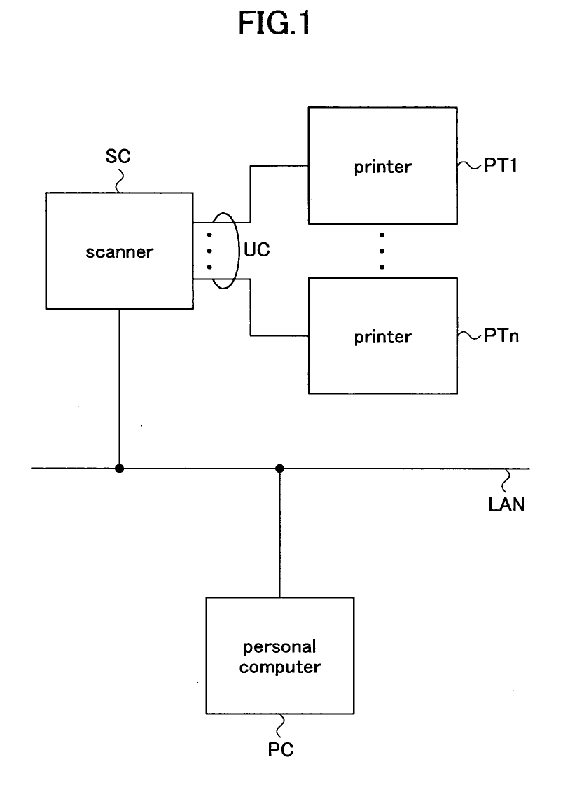

FIG. 1 is a block diagram schematically illustrating an example of a printing system according to an embodiment of the present invention.

In the printing system as shown in FIG. 1, a scanner SC and a personal computer PC are connected to a local area network (LAN), and plural printers PT1 through PTn are connected to the scanner SC through USB (Universal Serial Bus) cables UC.

In the present embodiment, basically, data communication between the scanner SC and the personal computer PC, which are connected to the local area network (LAN), is carried out by applying a combination of a transmission protocol up to a transport layer (the so-called TCP/IP), and a communication protocol on layers with higher ranks than the transport layer. This is the so-called Protocol Suite.

In addition, data communication between the scanner SC and the printers PT1 through PTn is carried out by appropriate communication protocols using USB cables, such as, PictBridge.

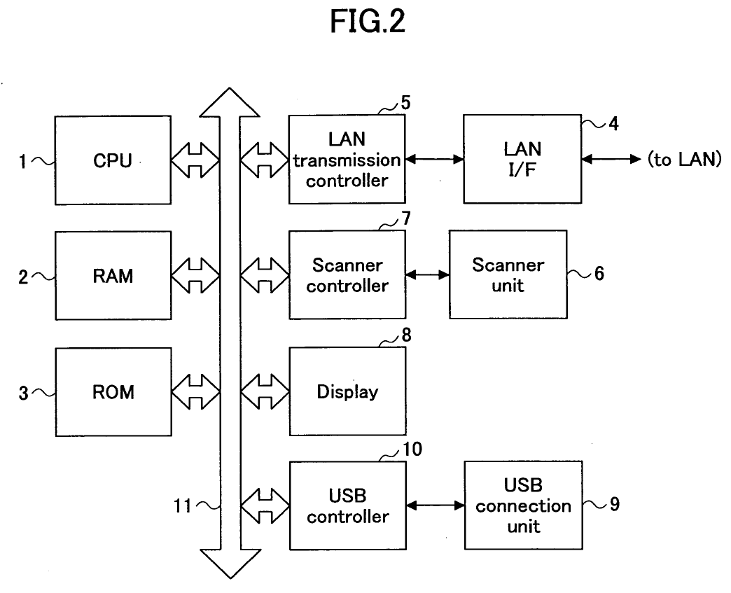

FIG. 2 is a block diagram illustrating a configuration of the scanner SC according to the present embodiment.

As shown in FIG. 2, the scanner SC includes a CPU (Central Processing Unit) 1, a RAM (Random Access Memory) 2, a ROM (Read Only Memory) 3, a local area network interface circuit 4, a local area transmission controller 5, the scanner unit 6, a scanner controller 7, an operations display 8, a USB connection unit 9, and a USB controller 10.

The CPU 1 controls operations of the scanner SC and performs various controls. The RAM 2 forms a working area of the CPU 1. The ROM 3 stores programs executed at the time when starting the CPU 1, and data required by the programs.

The local area network interface circuit 4 connects the scanner SC to the local area network LAN. The local area transmission controller 5 carries out communication control processes of various designated protocol suites in order for data communication to be performed with other data terminals through the local area network LAN.

The scanner unit 6 reads an image document with a preset graphic resolution and a preset color resolution.

The scanner controller 7 controls the operations of the scanner unit 6.

The operations display 8 is for a user to operate the scanner Sc, or for the scanner Sc to show the user various messages. For example, the operations display 8 may include various operational keys and various indicators.

The USB connection unit 9 may be a hub, or receptacle for connecting the USB cables UC.

The USB controller 10 performs various processing functions for communications in conformity to the USB standard.

In FIG. 2, the CPU 1, the RAM 2, the ROM 3, the local area transmission controller 5, the scanner controller 7, the operations display 8, and the USB controller 10 are connected to an internal bus 11, and data communications between these components are performed through the internal bus 11.

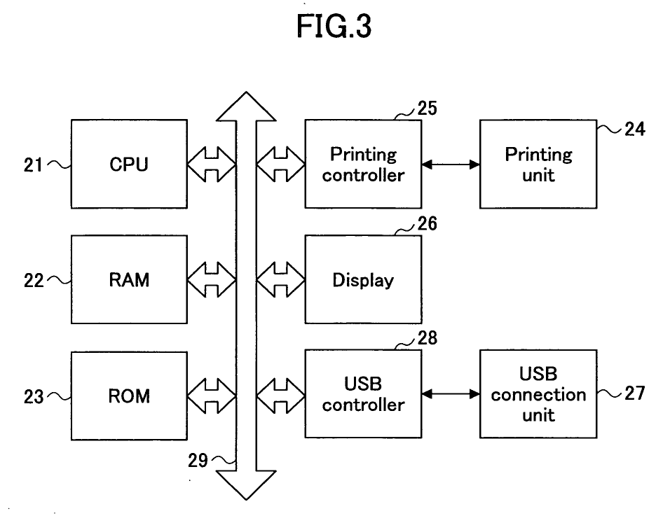

FIG. 3 is a block diagram illustrating a configuration of the printer PT (PT1 through PTn) according to the present embodiment.

As shown in FIG. 3, the printer PT includes a CPU (Central Processing Unit) 21, a RAM (Random Access Memory) 22, a ROM (Read Only Memory) 23, a printing unit 24, a printing controller 25, an operations display 26, a USB connection unit 27, and a USB controller 28.

The CPU 21 controls operations of the printer PT and performs various controls. The RAM 22 forms a working area of the CPU 21. The ROM 23 stores programs executed at the time when starting the CPU 1, and data required by the programs.

The printing unit 24 records and prints a print with a preset graphic resolution and a preset color resolution.

The printing controller 25 controls the operations of the printing unit 24.

The operations display 26 is for a user to operate the printer PT, or for the printer PT to show the user various messages. For example, the operations display 26 may include various operational keys and various indicators.

The USB connection unit 27 may be a hub or receptacle for connecting the USB cables UC.

The USB controller 28 performs various processing functions for communications in conformity with the USB standard.

In FIG. 3, the CPU 21, the RAM 22, the ROM 23, the printer controller 25, the operations display 26, and the USB controller 28 are connected to an internal bus 29, and data communications between these components are performed through the internal bus 29.

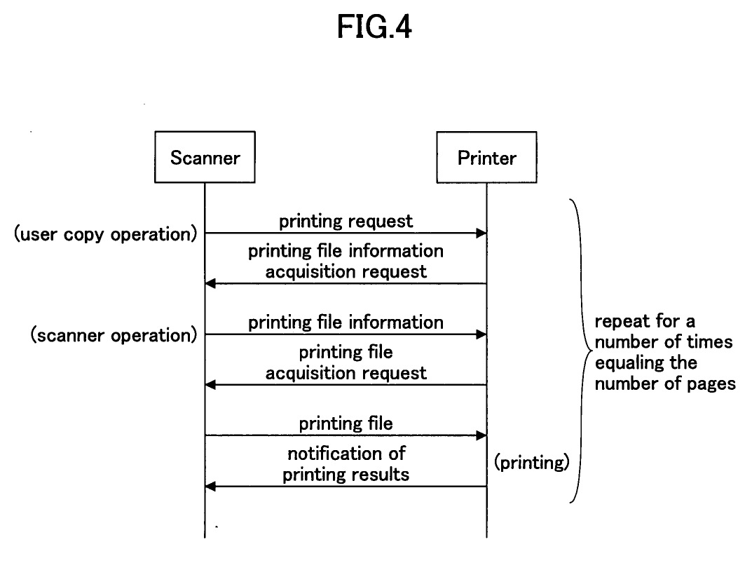

FIG. 4 is a sequence diagram exemplifying a copy operation according to the present embodiment, in which the scanner SC reads a copy of an image document, and the printer PT records and outputs the copy.

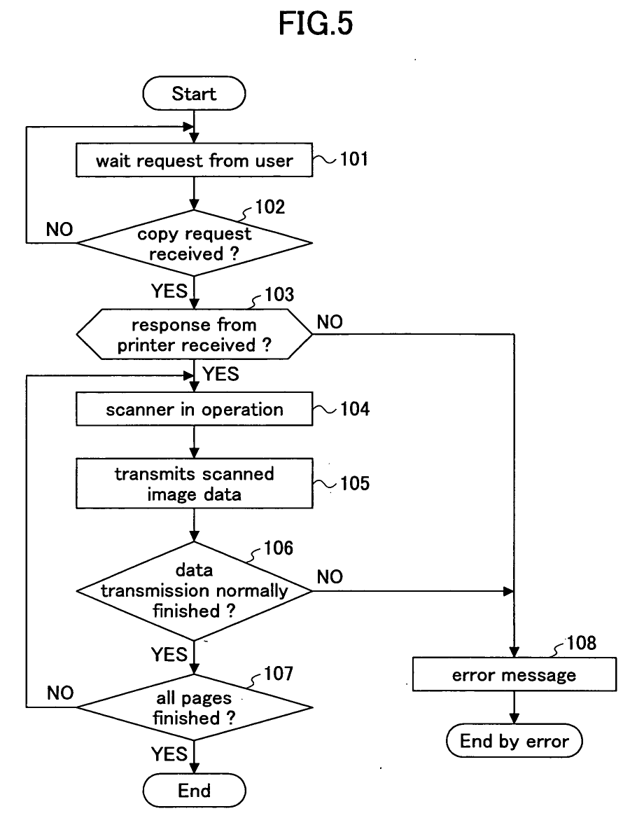

FIG. 5 is a flowchart exemplifying operations of the scanner SC during the copy operation as shown in FIG. 4.

In step 101 in FIG. 5, the scanner SC monitors whether a user conducts a copy operation, and waits until a request of the copy operation is received from the user.

In step 102, if the user sets a document sheet on the scanner unit 6, and operates the operations display 8 and instructs to execute the copy operation, the scanner SC sends a printing request to the printer PT1 through the USB cable. Upon receiving the request, the printer PT1 sends a request to the scanner SC to acquire information of the printing file.

In step 103, the scanner SC responds to the request from the printer PT1 of acquiring information of the printing file, and confirms whether a usual response from the printer PT1 is received.

If it is confirmed that the usual response from the printer PT1 is received, the routine proceeds to step 104, otherwise, the routine proceeds to step 108.

In step 104, the scanner controller 7 directs the scanner unit 6 to read an image document. At this moment, information of the printing file (size of printing paper, resolution, and others) is sent to the printer PT1 through the USB cable.

In step 105, the printer PT1 starts preparation of printing, and sends a request for acquiring the printing file to the scanner SC through the USB cable. Upon receiving the request, the scanner SC transmits the image data read by the scanner SC to the printer PT1 as the printing file through the USB cable.

The printer PT1 outputs a printing of the received printing file (image data), and notifies the scanner SC of the printing results through the USB cable.

In step 106, upon receiving the notification of the printing results, the scanner SC determines whether data transmission is finished normally.

If data transmission is finished normally, the routine proceeds to step 107, otherwise, the routine proceeds to step 108.

In step 107, the scanner SC determines whether all pages of the document to be read have been processed. If all pages of the document to be read have been processed, the copy operation is finished. Otherwise, the routine returns to step 104 to read the next page.

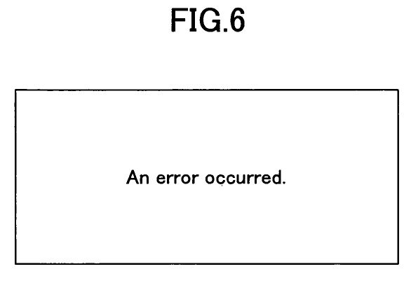

In step 108, when it is confirmed that the response from the printer PT1 is not received in step 103, or if it is determined that data transmission is not finished normally in step 106, an error message is displayed on the display 8 (as shown in FIG. 6), and the scanner SC notifies the user of the error massage. Then, the copy operation is finished by error.

FIG. 6 is a diagram showing an example of an error massage.

In the above example, since the scanner SC is connected to the printer through the USB cable, it is possible to provide a printing function with a simple system. In addition, even for a system not disclosed to a user (that is, the hardware is configured in this way), it is possible to freely select the engines (lasers or ink jets); thus, the development efficiency is improved.

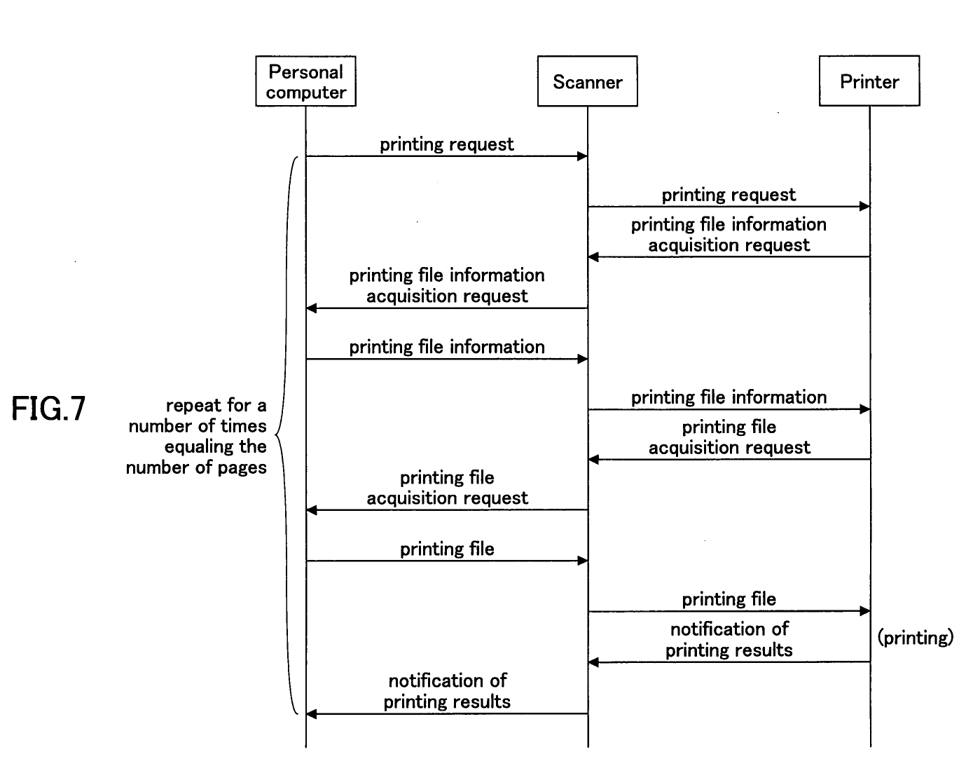

FIG. 7 is a sequence diagram illustrating an operation in which the personal computer PC sends a printing request to the printer PT through the scanner SC according to the present embodiment.

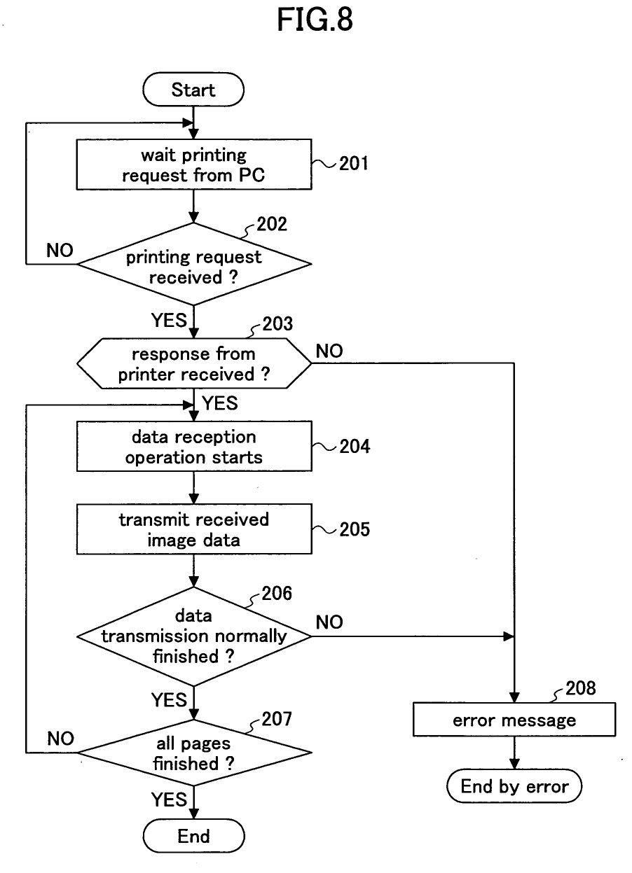

FIG. 8 is a flowchart illustrating operations of the scanner SC during the operation as shown in FIG. 7.

In step 201 in FIG. 8, the scanner SC monitors whether a printing request is received from the personal computer PC through the local area network LAN, and waits until the request is received.

In step 202, if the scanner SC receives a printing request from the personal computer PC, the scanner SC sends a printing request to the printer PT1 through the USB cable. Upon receiving the request, the printer PT1 sends a request to the scanner SC through the USB cable to acquire information of the printing file.

In step 203, the scanner SC responds to the request of acquiring information of the printing file from the printer PT1, which is made in response to the printing request, and confirms whether a usual response from the printer PT1 is received.

If it is confirmed that the usual response from the printer PT1 is received, the scanner SC notifies the personal computer PC of the printing file information acquisition request through the local area network LAN.

When the personal computer PC receives the printing file information acquisition request, the personal computer PC sends printing file information (printing paper size, resolution, and so on) concerning the printing data of the current printing job, and notifies the scanner SC of the printing file information through the local area network LAN. Upon receiving the notification, the scanner SC notifies the printer PT1 of the printing file information through the USB cable.

In order to start printing preparation and obtain the printing file, the printer PT1 sends the scanner SC the printing file acquisition request through the USB cable. Upon receiving the request, the scanner SC notifies the personal computer PC of the printing file acquisition request through the local area network LAN.

In step 204, the personal computer PC sends image data of the printing file to the scanner SC through the local area network LAN.

In step 205, the scanner SC sends the received image data to the printer PT1 through the USB cable.

The printer PT1 records and outputs a print of the received printing file (image data), and notifies the scanner SC of the printing results through the USB cable. Upon receiving the notification, the scanner SC notifies the personal computer PC of the printing results through the local area network LAN.

In step 206, upon receiving the notification of the printing results from the printer PT1, the scanner SC determines whether data transmission is finished normally.

If data transmission is finished normally, the routine proceeds to step 207, otherwise, the routine proceeds to step 208.

In step 207, the scanner SC determines whether the personal computer PC completes transmission of printing data of all pages of the document. If the personal computer PC completes transmission of printing data of all pages of the document, the printing operation is finished. Otherwise, the routine returns to step 204 to print the next page.

In step 208, when it is confirmed that the response from the printer PT1 is not received in step 203, or if it is determined that data transmission is not finished normally in step 206, an error message is displayed on the display 8 (as shown in FIG. 6), and the scanner SC notifies the user of the error massage. Then, the routine is finished by error.

In the above example, by employing communication functions of the local area network LAN of the scanner SC, it is possible to provide network printer functions for the personal computer PC, and it is possible to realize a network printer by using a printer PT1 without the communication functions.

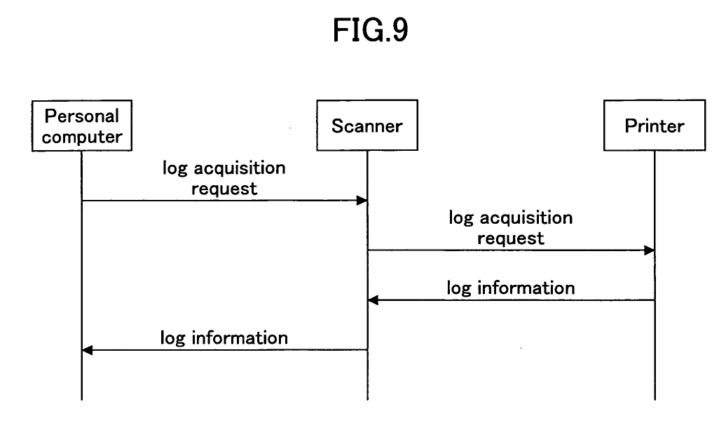

FIG. 9 is a sequence diagram exemplifying an operation in which the personal computer PC sends a log acquisition request to the printer PT through the scanner SC according to the present embodiment.

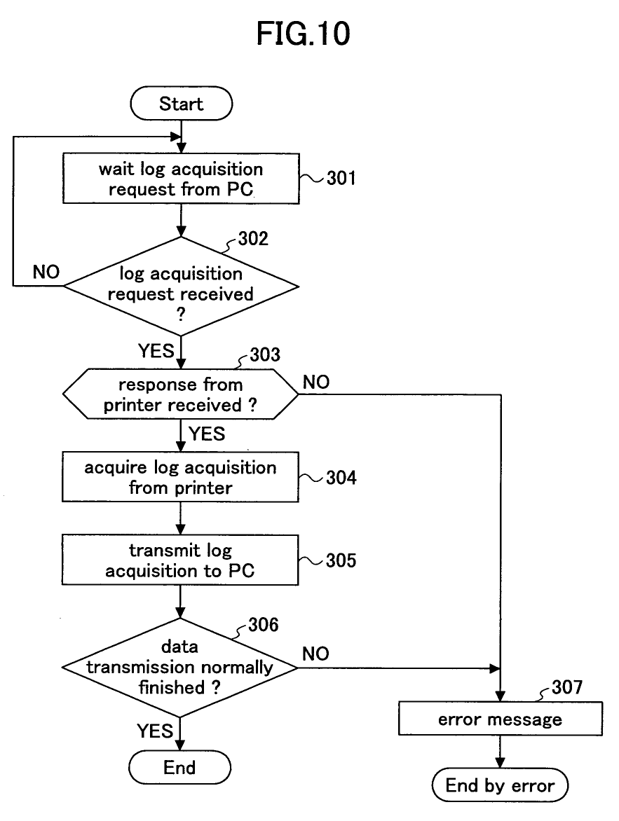

FIG. 10 is a flowchart exemplifying operations of the scanner SC during the operation as shown in FIG. 9.

In step 301 in FIG. 10, the scanner SC monitors whether a log acquisition request is received from the personal computer PC through the local area network LAN, and waits until the request is received.

In step 302, if the scanner SC receives a log acquisition request from the personal computer PC, the scanner SC sends a log acquisition request to the printer PT1 through the USB cable. Upon receiving the request, the printer PT1 creates log information, which represents status of the printer PT1 itself, and sends the log information to the scanner SC through the USB cable.

In step 303, the scanner SC responds to the log acquisition request, and confirms whether the log information is sent from the printer PT1.

If it is confirmed that the log information is sent from the printer PT1, the routine proceeds to step 304. Otherwise, the routine proceeds to step 307.

In step 304, the scanner SC obtains the log information from the printer PT1.

In step 305, the scanner SC sends the received log information to the personal computer PC through the local area network LAN.

In step 306, the scanner SC determines whether transmission of the log information is finished normally.

If data transmission is finished normally, the routine is finished. Otherwise, the routine proceeds to step 307.

In step 307, when it is confirmed that the response from the printer PT1 is not received in step 303, or if it is determined that data transmission is not finished normally in step 306, an error message is displayed on the display 8 (as shown in FIG. 6), and the scanner SC notifies the user of the error massage. Then, the routine is finished by error.

In the above example, by employing communication functions of the local area network LAN of the scanner SC, it is possible to handle the log acquisition request from the printer PT1 for the personal computer PC, thus allowing the personal computer PC to know the status of the printer PT1 which does not have the communication functions, hence enabling use of network utility.

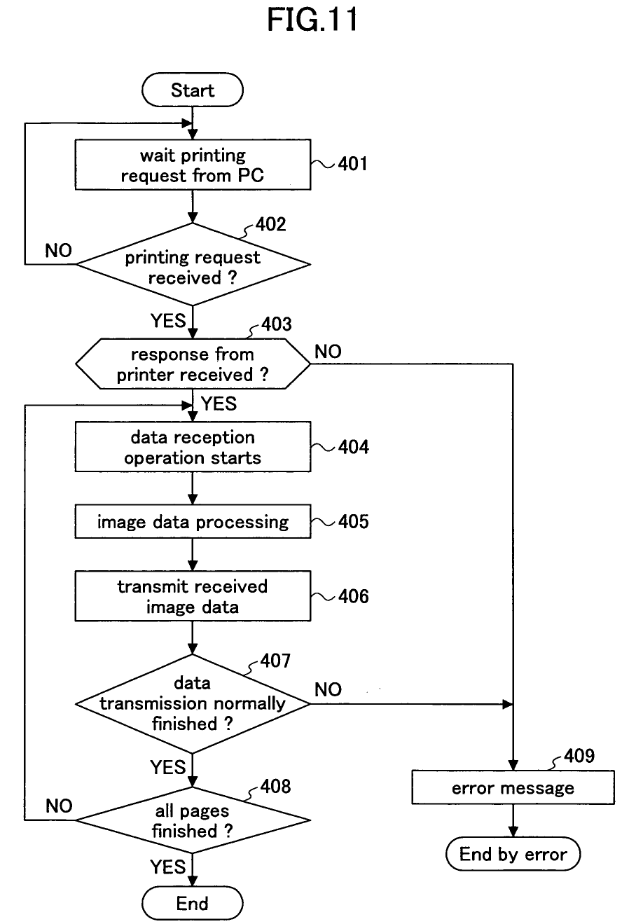

FIG. 11 is a flowchart illustrating another example of operations of the scanner SC when the personal computer PC sends a printing request to the printer PT through the scanner SC according to the present embodiment.

In step 401 in FIG. 11, the scanner SC monitors whether a printing request is received from the personal computer PC through the local area network LAN, and waits until the request is received.

In step 402, if the scanner SC receives a printing request from the personal computer PC, the scanner SC sends the printing request to the printer PT1 through the USB cable. Upon receiving the request, the printer PT1 sends a request to the scanner SC through the USB cable to acquire information of the printing file.

In step 403, the scanner SC responds to the printing file information acquisition request from the printer PT1, which is made in response to the printing request, and confirms whether a usual response from the printer PT1 is received.

If it is confirmed that the usual response from the printer PT1 is received, the scanner SC notifies the personal computer PC of the printing file information acquisition request through the local area network LAN.

When the personal computer PC receives the printing file information acquisition request, the personal computer PC sends printing file information (printing paper size, resolution, and so on) concerning the printing data of the current printing job, and notifies the scanner SC of the printing file information through the local area network LAN. Upon receiving the notification, the scanner SC notifies the printer PT1 of the printing file information through the USB cable.

In order to start printing preparation and obtain the printing file, the printer PT1 sends the scanner SC the printing file acquisition request through the USB cable. Upon receiving the request, the scanner SC notifies the personal computer PC of the printing file acquisition request through the local area network LAN.

In step 404, the personal computer PC sends image data of the printing file to the scanner SC through the local area network LAN.

In step 405, the scanner SC processes the received image data; specifically, the scanner SC converts the format of the received image data.

In step 406, the scanner SC sends the processed image data to the printer PT1 through the USB cable.

The printer PT1 records and outputs a print of the received printing file (image data), and notifies the scanner SC of the printing results through the USB cable. Upon receiving the notification, the scanner SC notifies the personal computer PC of the printing results through the local area network LAN.

In step 407, upon receiving the notification of the printing results from the printer PT1, the scanner SC determines whether data transmission is finished normally.

If data transmission is finished normally, the routine proceeds to step 408, otherwise, the routine proceeds to step 409.

In step 408, the scanner SC determines whether the personal computer PC completes transmission of printing data of all pages of the document. If the personal computer PC completes transmission of printing data of all pages of the document, the printing operation is finished. Otherwise, the routine returns to step 404 to print the next page.

In step 409, when it is confirmed that the response from the printer PT1 is not received in step 403, or if it is determined that data transmission is not finished normally in step 407, an error message is displayed on the display 8 (as shown in FIG. 6), and the scanner SC notifies the user of the error massage. Then, the routine is finished by error.

In the above example, since the image format can be converted on the side of the scanner, it is possible to provide functions such as size reduction or enlargement, collectiveness, and use of the page description language (PDL), which cannot be realized by a single printer because of limitation to the capacity of the memory of the printer.

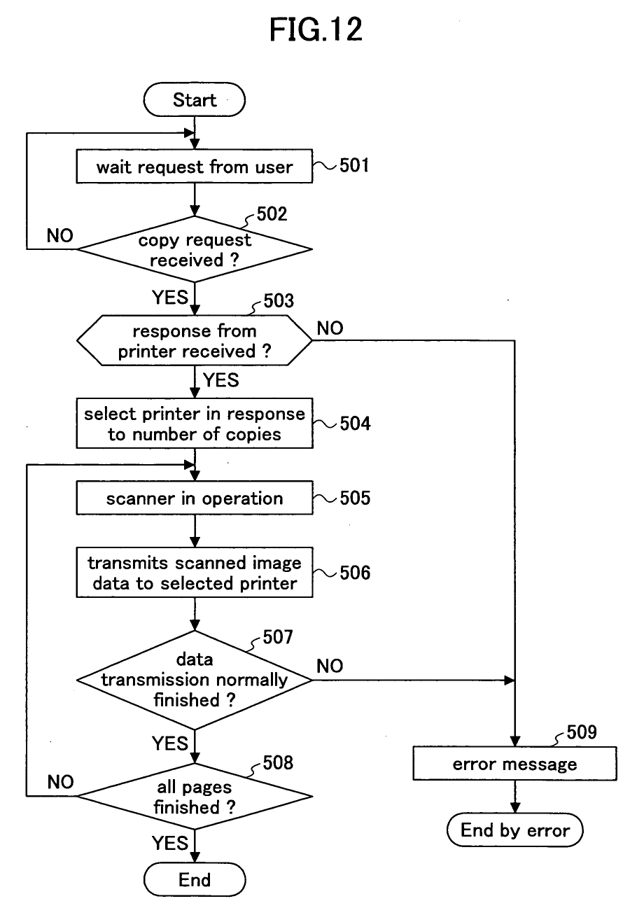

FIG. 12 is a flowchart illustrating another example of operations of the scanner SC during the copy operation as shown in FIG. 4.

In step 501 in FIG. 5, the scanner SC monitors whether a user conducts a copy operation, and waits until a request of the copy operation is received from the user.

In step 502, if the user sets a document sheet on the scanner unit 6, and instructs the execution of the copy operation by using the operations display 8, the scanner SC sends a printing request to all printers PT1 through PTn via the USB cables. Upon receiving the request, each of the printers PT1 through PTn sends a request to the scanner SC to acquire information of the printing file.

In step 503, the scanner SC responds to the requests from the printers PT1 through PTn of acquiring information of the printing file, and confirms whether usual responses from the printers PT1 through PTn are received.

If it is confirmed that the usual responses from the printers PT1 through PTn are received, the routine proceeds to step 504, otherwise, the routine proceeds to step 509.

In step 504, depending on number of copies to be made, which is specified in the received responses from the printers PT1 through PTn, the scanner SC selects printers to be used from the printers PT1 through PTn.

In step 505, the scanner controller 7 directs the scanner unit 6 to read an image document. At this moment, information of the printing file (size of printing paper, resolution, and others) is sent to the selected printers among the printers PT1 through PTn through the USB cables.

In step 506, the plural printers start preparation of printing, and send requests of acquiring the printing file to the scanner SC through the USB cables. Upon receiving the requests, the scanner SC transmits the image data read by the scanner SC to the printers as the printing files through the USB cables.

The selected printers output prints of the received printing files (image data), and notify the scanner SC of the printing results through the USB cables.

In step 507, upon receiving the notifications of the printing results, the scanner SC determines whether data transmission is finished normally.

If data transmission is finished normally, the routine proceeds to step 508, otherwise, the routine proceeds to step 509.

In step 508, the scanner SC determines whether all pages of the document to be read have been processed. If all pages of the document to be read have been processed, the copy operation is finished. Otherwise, the routine returns to step 504 to read the next page.

In step 509, when it is confirmed that the responses from the printers are not received in step 503, or if it is determined that data transmission is not finished normally in step 507, an error message is displayed on the display 8 (as shown in FIG. 6), and the scanner SC notifies the user of the error massage. Then, the copy operation is finished by error.

In the above example, by controlling plural printers at the same time, it is possible to distribute printing jobs to the plural printers, and this reduces cost.

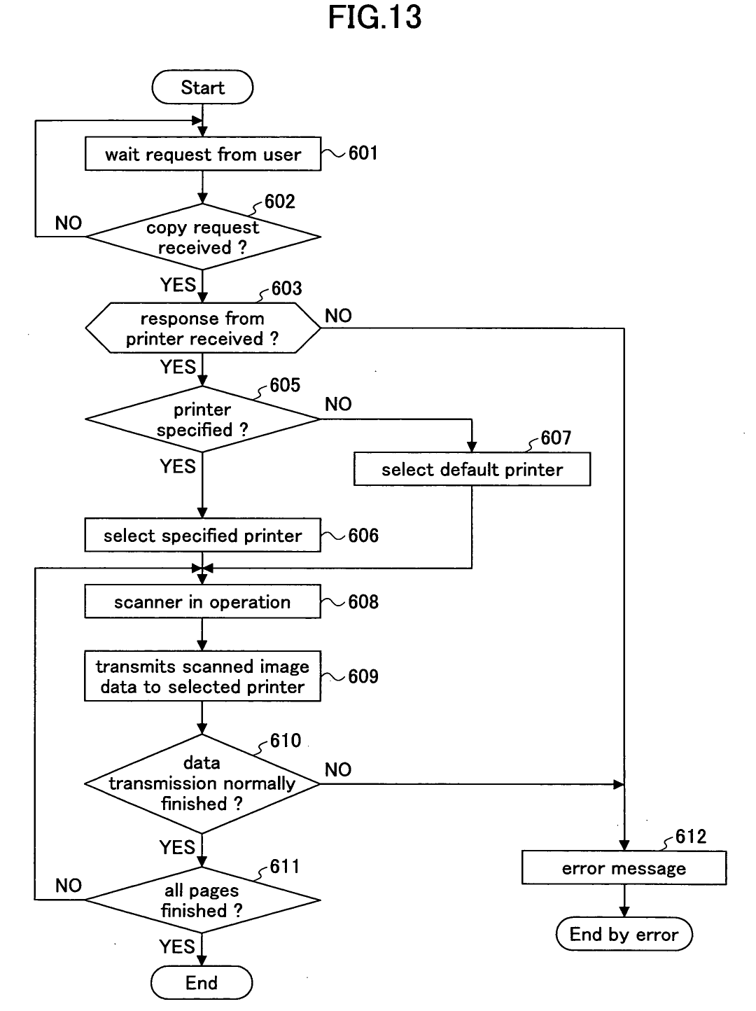

FIG. 13 is a flowchart illustrating still another example of operations of the scanner SC during the copy operation as shown in FIG. 4.

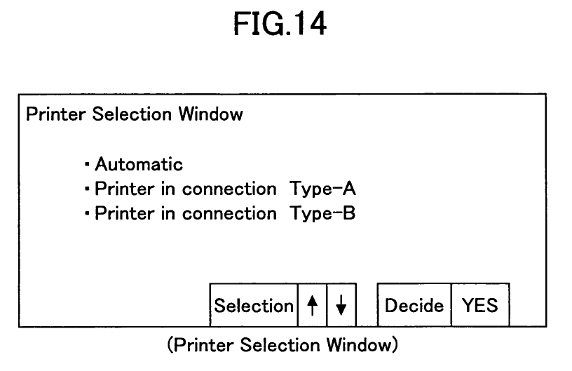

When executing the operations in FIG. 13, a printer selection window as shown in FIG. 14 is displayed on the operations display 8, and the user uses this printer selection window to select printers.

FIG. 14 is a block diagram schematically illustrating an example of a printer selection window according to the present embodiment.

In step 601 in FIG. 13, the scanner SC monitors whether a user conducts a copy operation, and waits until a request of the copy operation is received from the user.

In step 602, if the user sets a document sheet on the scanner unit 6, and instructs the execution of the copy operation by operating the operations display 8, the scanner SC sends a printing request to all printers PT1 through PTn via the USB cables. Upon receiving the request, each of the printers PT1 through PTn sends a request to the scanner SC to acquire information of the printing file.

In step 603, the scanner SC responds to the requests from the printers PT1 through PTn of acquiring information of the printing file, and confirms whether usual responses from the printers PT1 through PTn are received.

If it is confirmed that the usual responses from the printers PT1 through PTn are received, the routine proceeds to step 605, otherwise, the routine proceeds to step 612.

In step 605, the scanner SC determines whether a printer is specified by the user.

If the scanner SC determines a printer is specified by the user, the routine proceeds to step 606, otherwise, the routine proceeds to step 607.

In step 606, the scanner SC selects the specified printer as the printer to be used.

In step 607, the scanner SC selects the default printer as the printer to be used.

In step 608, the scanner controller 7 directs the scanner unit 6 to read an image document. At this moment, information of the printing file (size of printing paper, resolution, and others) is sent to the selected printer through the USB cable.

In step 609, the selected printer starts preparation of printing, and sends the scanner SC a request of acquiring the printing file through the USB cable. Upon receiving the request, the scanner SC transmits the image data read by the scanner SC to the printer as the printing file through the USB cable.

The selected printer outputs a print of the received printing file (image data), and notifies the scanner SC of the printing results through the USB cable.

In step 610, upon receiving the notification of the printing results, the scanner SC determines whether data transmission is finished normally.

If data transmission is finished normally, the routine proceeds to step 611, otherwise, the routine proceeds to step 612.

In step 611, the scanner SC determines whether all pages of the document to be read have been processed. If all pages of the document to be read have been processed, the copy operation is finished. Otherwise, the routine returns to step 608 to read the next page.

In step 612, when it is confirmed that the response from the printer is not received in step 603, or if it is determined that data transmission is not finished normally in step 610, an error message is displayed on the display 8 (as shown in FIG. 6), and the scanner SC notifies the user of the error massage. Then, the copy operation is finished by error.

In the above example, because of the operation of selecting printers by the user, it is possible to perform printing jobs efficiently.

It should be noted that the operations described in the above examples are also applicable to the operations of the scanner SC when the personal computer PC sends a printing request to the printer PT through the local area network LAN. In this case, the user of the personal computer PC is allowed to select a printer, and the selection results are sent to the scanner SC.

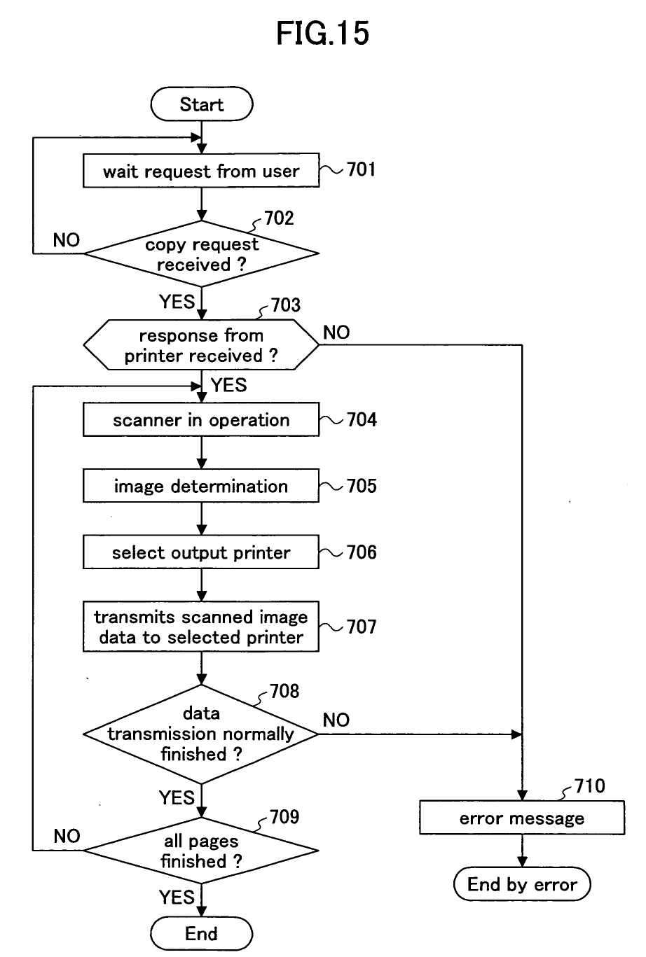

FIG. 15 is a flowchart illustrating yet another example of operations of the scanner SC during the copy operation as shown in FIG. 4.

In step 701 in FIG. 15, the scanner SC monitors whether a user conducts a copy operation, and waits until a request for the copy operation is received from the user.

In step 702, if the user sets a document sheet on the scanner unit 6, and instructs the execution of the copy operation by using the operations display 8, the scanner SC sends a printing request to all printers PT1 through PTn via the USB cables. Upon receiving the request, each of the printers PT1 through PTn sends a request to the scanner SC to acquire information of the printing file.

In step 703, the scanner SC responds to the requests from the printers PT1 through PTn of acquiring information of the printing file, and confirms whether usual responses from the printers PT1 through PTn are received.

If it is confirmed that the usual responses from the printers PT1 through PTn are received, the routine proceeds to step 704, otherwise, the routine proceeds to step 710.

In step 704, the scanner controller 7 directs the scanner unit 6 to read an image document.

In step 705, the scanner SC determines the type (color image, monochromatic image, and others) of the image from the current reading mode.

In step 706, based on the results of the determination, the scanner SC selects the printer to be used. For example, for a color image, an ink-jet printer is selected. Then, information of the printing file (size of printing paper, resolution, and others) is sent to the selected printer through the USB cable.

In step 707, in order to start preparation for printing and obtain the printing files, the selected printer sends a request for acquiring the printing file to the scanner SC through the USB cable. Upon receiving the request, the scanner SC transmits the image data read by the scanner SC to the selected printer as the printing file through the USB cable.

The selected printer outputs a print of the received printing file (image data), and notifies the scanner SC of the printing results through the USB cable.

In step 708, upon receiving the notification of the printing results, the scanner SC determines whether data transmission is finished normally.

If data transmission is finished normally, the routine proceeds to step 709, otherwise, the routine proceeds to step 710.

In step 709, the scanner SC determines whether all pages of the document to be read have been processed. If all pages of the document to be read have been processed, the copy operation is finished. Otherwise, the routine returns to step 704 to read the next page.

In step 710, when it is confirmed that the responses from the printers are not received in step 703, or if it is determined that data transmission is not finished normally in step 708, an error message is displayed on the display 8 (as shown in FIG. 6), and the scanner SC notifies the user of the error massage. Then, the copy operation is finished by error.

In the above example, since the printing engine can be selected automatically, it is possible to perform printing jobs efficiently.

It should be noted that the operations described in the above example are also applicable to the operations of the scanner SC when the personal computer PC sends a printing request to the printer PT through the local area network LAN. In this case, the scanner SC may check the printing data received from the personal computer PC to determine types of the image.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

For example, in the above, it is described that the scanner and the printer are connected by using USB cables, but the present invention is not limited to this. Other serial interface units having the same functions, such as, IEEE 1394, are also applicable. Here, the serial interface unit may be an interface unit by an interface scheme in which one signal line is used to transmit data one bit by one bit serially and continuously.

In addition, in the above, it is described that the printer outputs the image, resulting in visible images, but the present invention is not limited to this. The present invention is also applicable to visible display of an image on the operations display of the printer.

This patent application is based on Japanese Priority Patent Application No. 2005-267739 filed on Sep. 15, 2005, the entire contents of which are hereby incorporated by reference.

What is claimed is:

1. An image input device connected to an image output device through a serial interface unit, comprising:
a network communication unit connected to a network for communicating various data;
wherein
when the image input device receives a printing job from a host device through the network communication unit, the image input device sends information of the printing job to the image output device through the serial interface unit so that the image output device outputs a print of the printing job.

2. The image input device as claimed in claim 1, further comprising:
an image format conversion unit configured to convert an image format;
wherein
when the image input device receives a printing job from the host device through the network communication unit, the image format conversion unit converts the information of the printing job, and the image input device sends the converted information to the image output device through the serial interface unit so that the image output device outputs the print of the printing job.

3. An image input device connected to a plurality of image output devices through a serial interface unit, comprising:
a selection unit that, when a copy job of making a plurality of copies is submitted, selects one or more of the image output devices for use from the plural connected image output devices in response to the specified number of copies; wherein
the image input device sends image data obtained by reading to the selected image output devices to output respective prints.

4. The image input device as claimed in claim 3, wherein the selection unit selects the image output devices for printing.

5. The image input device as claimed in claim 3, wherein the selection unit selects the image output devices for printing in accordance with types of the image data to be printed.

6. An image input device that is connected to a plurality of image output devices through a serial interface unit, comprising:
a network communication unit connected to a network for communicating various data;
wherein
when the image input device receives a printing job for printing a plurality of copies from a host device through the network communication unit, the image input device selects one or more of the image output devices for use from the plural connected image output devices in response to the specified number of copies, and sends information of the printing job to the selected one or more image output devices through the serial interface unit to output prints.
